(19) United States
(12) Patent Application Publication
(10) Pub. No.: US 2026/0093316 A1
(43) Pub. Date: Apr. 2, 2026

(54) CASCADING APPROACH TO DETECTING AND INTERPRETING USER ACTIVITY

(71) Applicant: Apple Inc., Cupertino, CA (US)

(72) Inventors: Ian R. Fasel, San Francisco, CA (US); Victor Belyaev, San Jose, CA (US)

(21) Appl. No.: 19/336,323

(22) Filed: Sep. 22, 2025

Related U.S. Application Data
(60) Provisional application No. 63/700,313, filed on Sep. 27, 2024.

(51) Int. Cl. G06F 3/01

(52) U.S. Cl. CPC G06F 3/011

(57) ABSTRACT

Various implementations disclosed herein include devices, systems, and methods that detect and interpret a user activity using a resource-heavy process that is triggered or guided by determinations made by a resource-light process. For example, a method may include performing a first process to produce an output. The first process may include detecting events based on a first set of sensor data; identifying a subset of the events as human-relevant events corresponding to one or more predetermined classes depicted in the first set of sensor data; and collecting information regarding the human-relevant events based on the first set of sensor data. Based on the output of the first process, a second process may be performed to interpret a user activity. The second process may include obtaining a second set of sensor data and interpreting the user activity using the second set of sensor data.

### CROSS-REFERENCE TO RELATED APPLICATIONS

This Application claims the benefit of U.S. Provisional Application Ser. No. 63/700,313 filed Sep. 27, 2024, which is incorporated herein in its entirety.

### TECHNICAL FIELD

The present disclosure generally relates to systems, methods, and devices that detect and interpret a user activity using a resource intensive process that is triggered or guided by analysis obtained from an initial resource-light process.

### BACKGROUND

Existing techniques for detecting user activities may be improved with respect to accuracy, power consumption, and/or the types of user activities detected (e.g., activities that involve combinations of motion, sounds, gaze, etc.).

### SUMMARY

Various implementations disclosed herein include devices, systems, and methods that detect and interpret user activity via a resource-heavy process triggered and/or guided by determinations and decisions initially performed by a resource-light process. For example, a resource-light process may operate continuously (or near continuously) using sensor data (e.g., hand position data, gaze data, audio data, inertial measurement unit (IMU) data) from fewer sensors and compute resources than a resource-heavy process that utilizes sensors and data such as, cameras, camera settings, large language models (LLMs), etc. requiring more power and compute resources.

In some implementations, a resource-heavy process and a resource-light process may be configured to obtain differing multi-modal inputs. For example, a resource-light process may detect and collect data associated with human-relevant events such as, inter alia, sounds, actions associated with interacting with an object, user movement actions, etc. Likewise, a resource-light process may detect and classify current events and/or objects of interest being interacted with to trigger and/or guide improved resource-heavy process decisions. In some implementations when a trigger event is detected, an LLM (of the resource-heavy process) may be activated to further analyze the trigger event via high-powered, multimodal processing that may obtain inputs such as images, audio, and/or contextual data. Subsequent processing an event may then occur. The resource-heavy process may be configured to generate a further output or prediction, e.g., a textual description of a user activity. In some implementations, multi-modal input may include, inter alia, user voice input, user gaze input, user hand or finger input, body language input, etc.

In some implementations, a first subset of resource-light processes (e.g., performed by audio sensors) may be configured to control operation of a second subset of resource-light processes such that the second subset of resource-light processes (e.g., performed by cameras) may be analyzed by an LLM subsequent to the LLM analyzing resulting audio signals. For example, the first subset of resource-light processes may include audio detection sensing (e.g., detecting speech) that triggers a limited capacity of the LLM (e.g., review of audio data without image data) to interpret speech and based on the interpreted speech, it may be determined if a resource-heavy process is necessary. If it is determined that a resource-heavy process is necessary, usage of the second subset of resource-light processes (e.g., cameras) may be triggered to capture images for resource-heavy processes such as an LLM with a video encoder, image processing, etc. to analyze hand/gaze gestures as described with respect to the following example:

In some implementations, a user may recite a spoken command: “when was automobile type A made”. In this instance, an LLM is only needed in limited capacity to analyze audio data as there is no need to enable cameras to perform any resource-heavy processes such as hand/gaze detection algorithms as the spoken command does not include any words that would indicate that the user is referencing an item in a current physical environment.

Alternatively, if the user recites a spoken command “when was that car made”, an LLM may be first utilized in a limited capacity (only requiring audio data) to interpret the spoken command (e.g., the user is requesting information related to a car in its environment) and based on an output of the LLM, the process may determine that resource-heavy processes (e.g., image capture and object detection) are necessary to identify that a car is in the physical environment. As a result, cameras may be activated to capture images and higher computation processes such as image detection may be performed. In response, if only one car is detected, the process may assume the user is referring to that car. However, if there are two cars in the physical environment, then the process is configured to enable another resource-heavy process such as, for example, a hand/gaze recognition process to determine which car the user was referencing when the term “that” was recited.

In some implementations, a device has a processor (e.g., one or more processors) that executes instructions stored in a non-transitory computer-readable medium to perform a method. The method performs one or more steps or processes. In some implementations, the method performs a first process to produce an output. The first process includes: detecting events based on a first set of sensor data; identifying a subset of the events as human-relevant events corresponding to one or more predetermined classes depicted in the first set of sensor data; and collecting information regarding the human-relevant events based on the first set of sensor data. Based on the output of the first process, the method performs a second process to interpret a user activity. The second process includes obtaining a second set of sensor data and interpreting the user activity using the second set of sensor data.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment, in accordance with some implementations.

FIGS. 2A and 2B illustrate a view of a system that includes a low-power system outputting information via a human relevance module to trigger a high-power system, in accordance with some implementations.

FIG. 3 illustrates a view of a system that incorporates a low-level signal processing system with a high-powered multimodal language modeling system to capture detailed behaviors and events in real-time, in accordance with some implementations.

FIG. 4 illustrates a process for using the system of FIG. 2 to enable an example for locating a car in a garage, in accordance with some implementations.

FIG. 5 illustrates a view of a system that enables system activation using low-level signals as triggers, in accordance with some implementations.

FIG. 6 is a flowchart representation of an exemplary method that detects and interpret user activity via a resource-heavy process triggered and/or guided by determinations and decisions enabled by a resource-light process, in accordance with some implementations.

FIG. 7 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

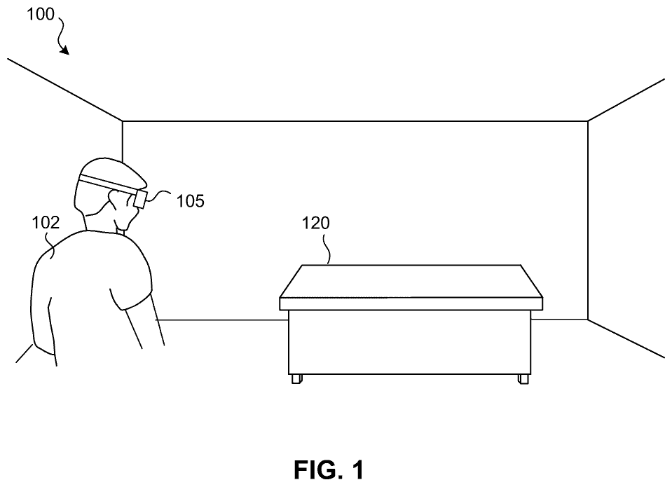

FIG. 1 illustrates an exemplary electronic device 105 operating in a physical environment 100. In the example of FIG. 1, the physical environment 100 is a room that includes a desk 120. The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, a system including electronic device 105 may be configured to perform a first process such as a resource-light process (e.g., using low compute and/or low power sensors, etc.) to produce an output that may be configured to trigger a second process or may include information used to guide the second process.

In some implementations, the first process may include detecting events based on a first set of sensor data. For example, events may include, inter alia, hand position events, gaze direction events, audio events, inertial measurement unit (IMU) events, etc.

In some implementations, the first process may further include identifying a subset of events as human-relevant events corresponding to one or more predetermined classes depicted in the first set of sensor data. For example, identifying the subset of events as human-relevant events may include using a human foundation model (HFM) and a relevance decoder to identify events such as hand and gaze events, hand-object interaction events, visual attention to object events, text reading events, user-initiated speech or sound-based events, human body movement events, etc.

In some implementations, the first process may further include collecting information associated with the human-relevant events based on the first set of sensor data. Collecting the information may be performed by collecting the first set of sensor data continuously.

In some implementations, a second process is performed or triggered based on an output of the first process. The second process is configured to interpret a user activity by obtaining a second set of sensor data (e.g., vision sensor data, increase frame rate data, increase resolution data, etc.) and interpreting the user activity using the second set of sensor data. For example, interpreting the user activity may include LLM processing.

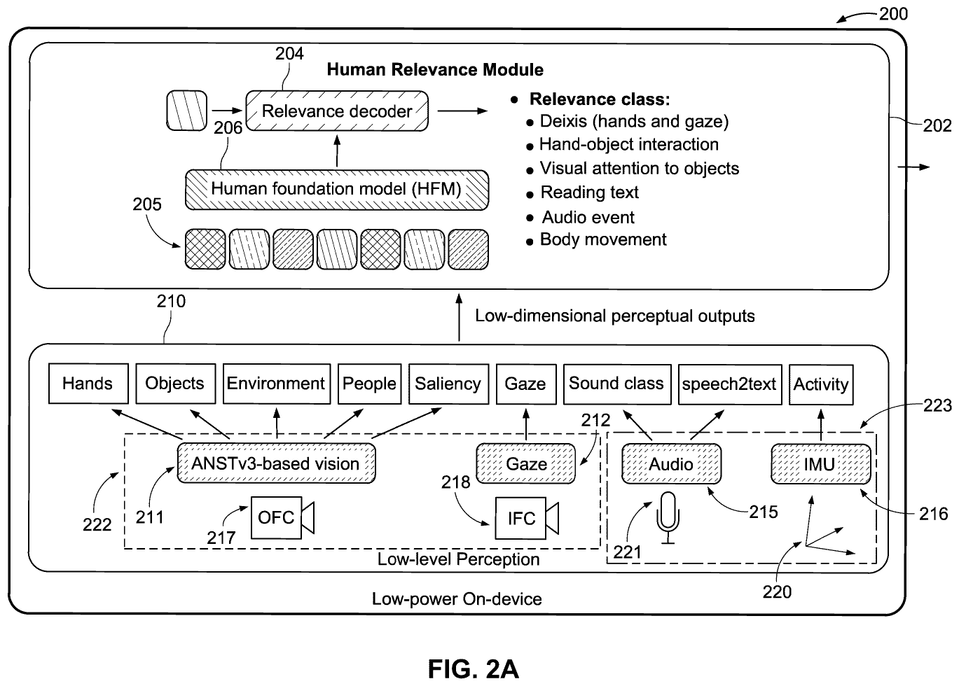

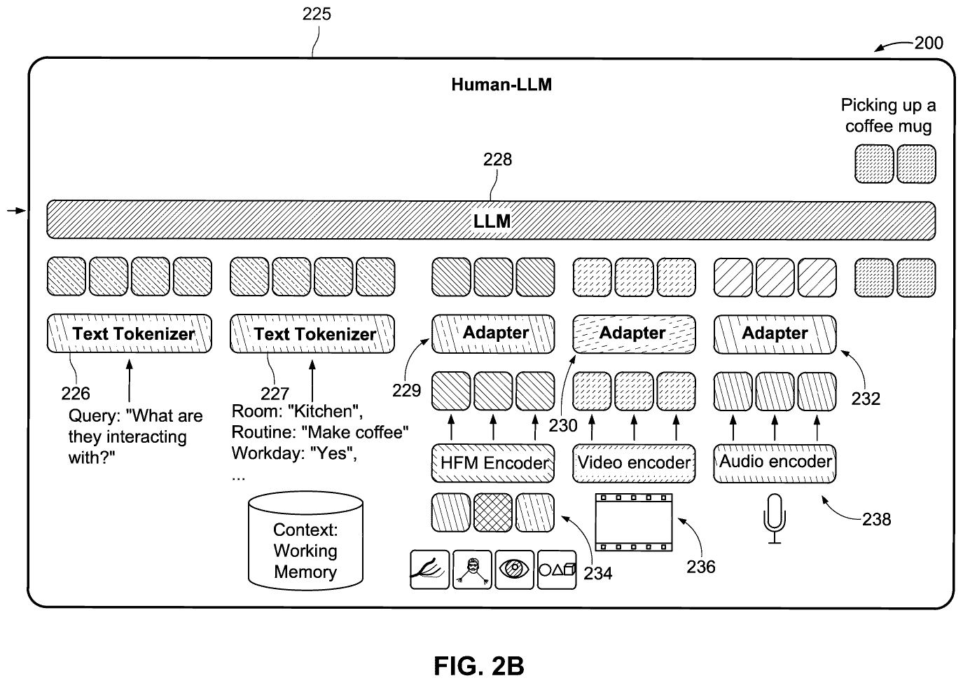

FIGS. 2A and 2B illustrate a view of a system 200 that includes a low-power system 210 outputting information via a human relevance module 202 to trigger a high-power (multimodal language model) system 225 that includes an LLM 228, in accordance with some implementations. In some implementations, low-power system 210 may include low-power, event-driven modules to serve as initial detectors. Likewise, high-power system 225 may only be activated when relevant signals are triggered (e.g., from human relevance module 202). System 200 ensures that computationally expensive models are only engaged when necessary thereby optimizing both power consumption and processing efficiency of system 200.

Low-power system 210 is configured to use multiple sensory modules (e.g., modules 211, 212, 215, and 216) to detect, track, and interpret various events or interactions (via HFM 206 and relevance decoder 204 of human relevance module 202 to identify events 205) in an environment without relying on a full-scale language model. For example, low-power system 210 may be configured to operate with minimal computational resources, focusing on processing essential, low-dimensional signals from sensors (of modules 211, 212, 215, and 216) such as, inter alia, cameras (for object, hand, and environment tracking), audio sensors (for sound classification, speech-to-text, etc.), and additional sensor inputs (e.g., gaze tracking, motion sensing, etc.).

In some implementations, modules 211 and 212 and associated sensors 217 and 218 are included in a first group 222 of low power/low compute module/sensors. In some implementations, modules 215 and 216 and associated sensors 221 and 220 are included in a second group 223 of low power/low compute module/sensors having lower power consumption/compute than the first group 222 of low power/low compute module/sensors. In some implementations, operation of the first group 222 of low power/low compute module/sensors may be triggered by high-power system 225 upon detection of, for example, audio (e.g., speech) that triggers a limited capacity of an LLM 228 to interpret the audio. Based on the interpreted audio, the first group 222 of low power/low compute module/sensors may be triggered (e.g., cameras) to capture images for a resource-heavy process to, for example, evaluate hand/gaze gestures.

Module 211 is a visual perception module configured to perform object detection activities. For example, module 211 may be configured to use outward-facing cameras (OFC) 217 to detect objects, hands, people, and environmental features such as lighting, space, etc. Likewise, module 211 may be configured to enable saliency detection such as, for example, identifying areas within a visual field (of a user) that are most likely to be relevant to the user. For example, objects being interacted with.

Module 212 is configured to enable gaze detection functionality. For example, module 212 may be configured to enable inward-facing cameras (IFC) 218 to monitor user behavior such as a direction that a user is looking, a focus or attention to objects or surroundings, etc.

Module 215 is an audio perception module configured to use a sensor(s) 221 (e.g., a microphone) to enable sound classification processes, speech-to-text processes, and behavioral prediction processes. For example, a sound classification process may be configured to recognize environmental sounds or speech, classify activities such as chewing or eating, etc. Likewise, behavioral prediction process is configured to perform audio-based behavior recognition combined with other sensory inputs such as, for example, distinguishing if a person is talking (e.g., a verbal utterance) while walking or sitting.

Module 216 is configured to detect user activities (e.g., via IMU sensors 220) such as walking, running, standing, sitting, and/or transitions between these activities.

In some implementations, low-power system 210 may operate continuously to identify events or changes in the environment or user behavior that may be relevant such as, for example, a loud sound, a person pointing, moving, or interacting with an object, etc. Accordingly, once a relevant event is detected, low-power system 210 may generate a low-power output (e.g., a trigger event) that signals an occurrence of a relevant event.

In some implementations, an audio signal from audio sensors (e.g., sensors 221) may be used to trigger limited use of LLM 228 and based on results of analysis performed by LLM 228 with respect to the audio signal, low power sensors (e.g., sensors 217) such as cameras (e.g., the cameras are higher power sensors than the audio sensors) may be activated such that LLM 228 may enable multimodal processing,

For example, the second group 223 of low power/low compute module/sensors (associated with a subset of resource-light processes) may be configured to control operation of the first group 222 of low power/low compute module/sensors (another subset of resource-light processes) such that processes executed by the first group 222 of low power/low compute module/sensors (e.g., performed by cameras) may be performed by LLM 228 after LLM 228 has analyzed associated audio signals. Accordingly, the second group 223 of low power/low compute module/sensors may include audio detection functionality (e.g., detecting speech) that triggers limited capacity of LLM 228 (e.g., review of audio data without image data) to interpret speech. Based on the interpreted speech, it may be determined if a resource-heavy process should be implemented via full capacity usage of LLM 228. If it is determined that a resource-heavy process should be implemented, usage of the other sensors (e.g., cameras of the first group 222 of low power/low compute module/sensors) may be triggered to capture images for resource-heavy processes such as LLM 228 usage with a video encoder of image system 236, etc. as described with respect to the following example:

In some implementations, a user may recite a spoken command: “what year was automobile type A manufactured”. In this instance, LLM 228 is enabled in a limited capacity to analyze only audio data as there is no need to enable cameras to perform resource-heavy processes such as hand/gaze detection algorithms as the spoken command does not include any words that indicate that the user is referencing an item in a current physical environment.

Alternatively, if the user recites a spoken command “when was that car manufactured”, LLM 228 may be initialized in a limited capacity (to analyze audio data) to interpret the spoken command (e.g., the user is requesting information related to a car in a current environment) and based on an output of LLM 228, the process may determine that resource-heavy processes (e.g., image capture and object detection) are necessary to identify that a car is in the physical environment. In response, cameras may be activated to capture images and higher computation processes such as image detection may be performed. In response, if only one car is detected, the process may assume the user is referring to that car. Likewise, if there are two cars in the physical environment, then the process may be configured to enable another resource-heavy process such as, for example, a hand/gaze recognition process to determine which car the user was referencing when the term “that” was recited.

In some implementations when a trigger event is detected, system 200 activates LLM 228 to further analyze the event via high-power, multimodal processing that obtains inputs such as images (e.g., video frames) from an image system 236, audio from an audio system 238, and contextual data from a contextual system 234. For example, if low-power system 210 detects a hand-object interaction, high-power system 225 may be configured to process full image sequences to generate a prediction such as, for example, “the user is picking up a coffee mug”.

In some implementations, high-power system 225 may be configured to process multiple input types such as, for example, sequences of images (from a camera) or audio clips (for speech or sound analysis with respect to a verbal utterance) to generate a more detailed understanding of the event. The multiple input types may be processed via modules 226, 227, 229, 230, and 232 for input into LLM 228.

In some implementations, high-power system 225 may be configured to use additional contextual data such as, inter alia, a location (from room detection), historical patterns (e.g., typical actions at a specific time), calendar data to sharpen an analysis, etc. The additional contextual data may enable event interpretations such as, for example, determining that it's 8 a.m., a user is in the kitchen, and the user typically drink coffee at this time.

Subsequent to processing an event, high-power system 225 may generate a further output or prediction that includes a textual description such as: a user picked up a coffee mug at 8:15 a.m. in the kitchen. Likewise, the further output or prediction may include higher-level feature embeddings, such as: embeddings from image or video analysis, embeddings for audio-based analysis, behavioral embeddings for detecting temporal or action-based patterns, etc. The aforementioned embeddings may be stored for later analysis, future queries, or integration into other systems.

Accordingly, system 200 implements a process that enables an always on perception layer (low-power system 210) that conserves power by only using lightweight perceptual models (e.g., modules 211, 212, 215, and 216) to generate low-dimensional signals and only trigger higher computational models when a relevant event occurs thereby ensuring that heavy compute resources (e.g., full-image processing or multimodal analysis) are only used when necessary. System 200 may continuously develop an understanding of a user's environment and activities, moving from low-power initial detection to deeper analysis if needed.

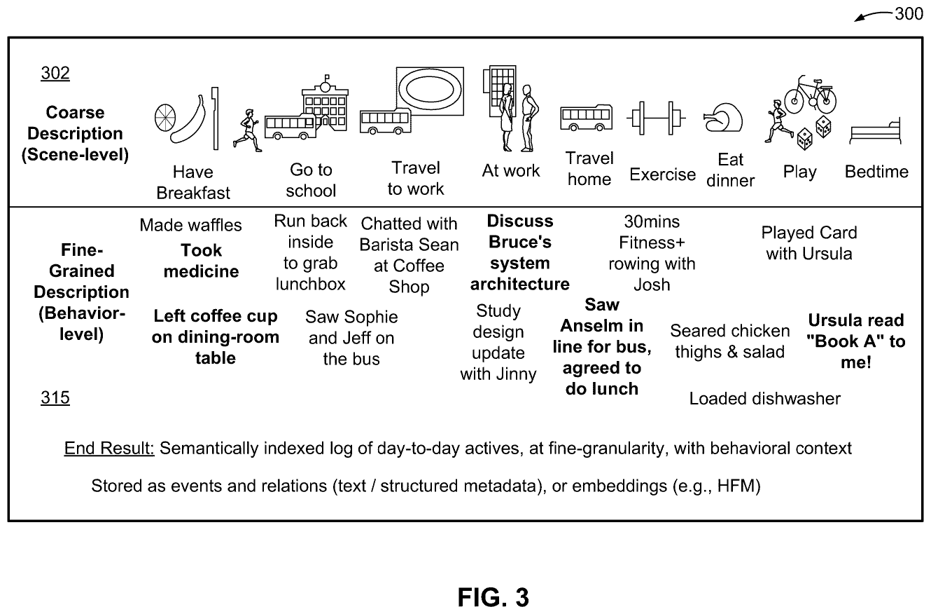

FIG. 3 illustrates a view of a system 300 that incorporates a low-level signal processing system 302 with a high-powered multimodal language modeling system 315 to capture detailed behaviors and events in real-time, in accordance with some implementations.

Low-level signal processing system 302 may be configured to run continuously to detect basic scene level signals and patterns from sensors such as motion detectors, microphones, etc. to capture coarse, scene-level descriptions such as, for example, the user is having breakfast or is heading to work.

High-powered multimodal language modeling system 315 may be enabled only when significant events are detected thereby providing detailed interpretations of the significant events.

For example, a multi-level process may be enabled such that low-level signal processing system 302 continuously monitors user behavior and triggers high-powered multimodal language modeling system 315 only when specific events are detected. Accordingly, fine-grained, moment-by-moment behaviors such as “you took medicine” or “you left a coffee cup on the dining-room table” may be captured.

The aforementioned multi-level process results in a semantic index or log of day-to-day activities with each detected event being tagged and stored in real time thereby allowing for tracking of detailed behaviors and relationships between events, which may be useful for various applications such as health monitoring, personal diaries, productivity analysis, etc.

Accordingly, system 300 may provide real-time fine-grained logging of behaviors while balancing power efficiency by leveraging low-level signal processing system 302 to trigger the more powerful, expensive high-powered multimodal language modeling system 315 on demand.

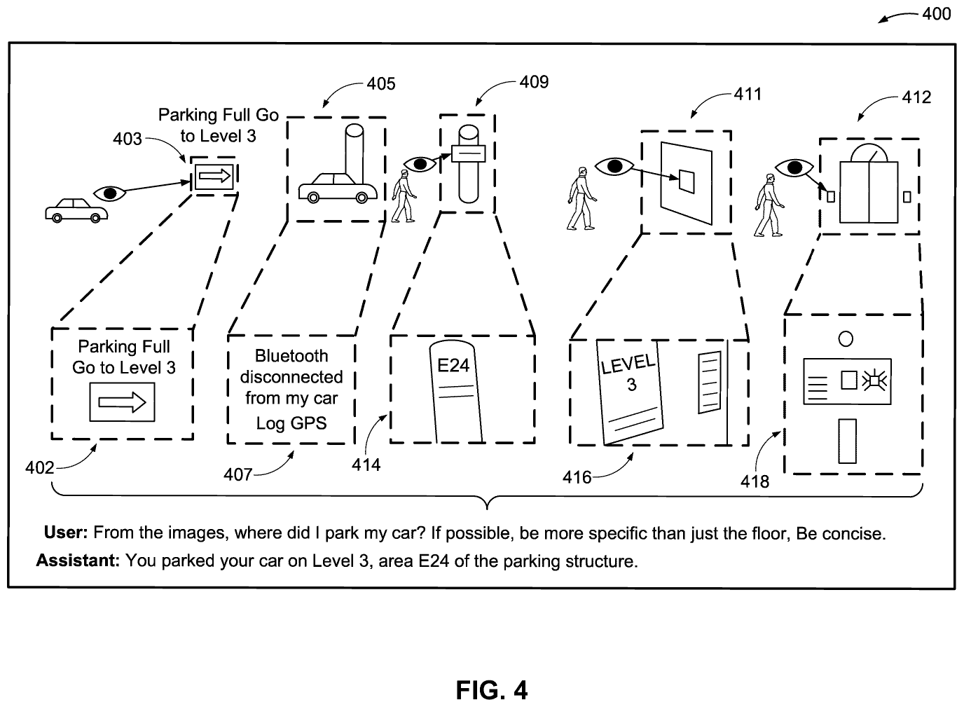

FIG. 4 illustrates a process 400 for using system 200 of FIG. 2 to enable an example for locating a car in a garage, in accordance with some implementations. Process 400 is configured to assist users to remember events by intelligently capturing and processing key interactions. Process 400 enables a blend of real-time data collection and event-driven processing to balance power consumption with functionality.

In some implementations, process 400 is configured to create a software assistant to operate real time logging interactions or events for future queries. In some implementations, process 400 is configured to collect data related to user behavior, preferences, and environment while only logging relevant events to save battery life and processing power. Accordingly, a selective data collection process may be implemented such that instead of continuously recording video or monitoring every action or event, process 400 may trigger data collection only at specific moments that are likely to be important or useful to a user.

For example, if a user is driving to the airport and glances at a sign 402 that states: “Parking Full Go to Level 3”, process 400 may recognize that the user is reading the sign and may capture a snapshot 403 of this event. Likewise, as the user parks the car, process 400 may log a location 405 based on detecting a wireless system (e.g., a Bluetooth system), GPS, or other sensors being disconnected 407 and subsequently gather contextual data 409, 411, and 412 such as, inter alia, signs 414 or 416 viewed by the user or buttons 418 that have been activated by the user.

In some implementations, process 400 may be configured to process multiple forms of data such as, inter alia, images, text, GPS signals, object interaction data, etc. The multiple forms of data may be processed by detecting and identifying key moments (of the data), such as, for example, reading a parking sign, pushing a button for the elevator, exiting a car, etc. In some implementations, the detected and identified key moments may be transmitted to a multimodal language model (e.g., LLM in FIG. 228) to provide answers to questions such as, for example, “Where did I park my car?”. Subsequently, associated images, text, and interaction logs may be combined into a query sent to the multimodal language model provide a correct answer to the question(s).

In some implementations, interactions associated with process 400 may be stored in a log or database that may be queried later. For example, an interaction may be associated with moments where the user interacted with the world in a meaningful way such as, gazing at a sign, pressing a button, etc. Accordingly, if a user subsequently asks a question such as, for example, “Where did I park my car?”, process 400 may use a voice query to trigger a search with respect to a log of key events and retrieve snapshots or contextual data points relevant to the question. Accordingly, process 400 is configured to detect when a user is engaged in meaningful activities (e.g., reading a sign, interacting with objects, etc.) thereby minimizing power consumption while gathering enough data to provide useful insights.

In some implementations, sensors such as gaze tracking, wireless signal disconnects, or object interaction tracking may serve as low-power, always-on components that signal when to collect more detailed data. Therefore, instead of producing a continuous feed of data (e.g., from the last few days), process 400 may filter and retrieve snapshots of the most relevant events. For example, instead of reviewing a video of the last few hours, process 400 may retrieve only moments in time when a user interacted with a specific parking sign or parked a car thereby streamlining a query process and making it faster and more efficient to obtain useful information without unnecessary data overload.

In some implementations, process 400 may incorporate machine learning (ML) to predict relevant user moments and use the relevant user moments to enable the ML to improve over time with respect to recognizing patterns and predicting when data capture may be useful.

In some implementations, process 400 may enable complex queries, such as requesting summaries of a user's day or week by piecing together the aforementioned snapshots into a coherent timeline of key events.

Accordingly, process 400 may intelligently balance data collection and processing efficiency, capturing key moments that are relevant to a user's activities, while minimizing power consumption by using sensors to detect the key moments in real time. This selective, event-driven approach allows process 400 to function as a highly effective personal assistant that may provide timely help and recall based on past interactions.

In some implementations, process 400 enables cascading sensor and processing operations such that a first subset of low power sensors (e.g., audio sensors) is initialized to capture data, such as audio data, for input into an LLM (operating in a limited, single-modal capacity) configured to evaluate the audio data. Subsequently, additional higher power sensors such as cameras may be enabled for providing input into the LLM (operating in a multi-modal capacity) to interpret environmental context and hand and gaze gestures. For example, operation of first low power/low compute sensors may be triggered upon detection of, for example, audio data such as speech. This operation may be configured to trigger a limited capacity of an LLM to interpret the speech and based on the interpreted speech, the second differing (and higher power) sensors may be triggered (e.g., cameras) to capture images for evaluation of hand and gaze gestures to refine a result indicating a user request or command.

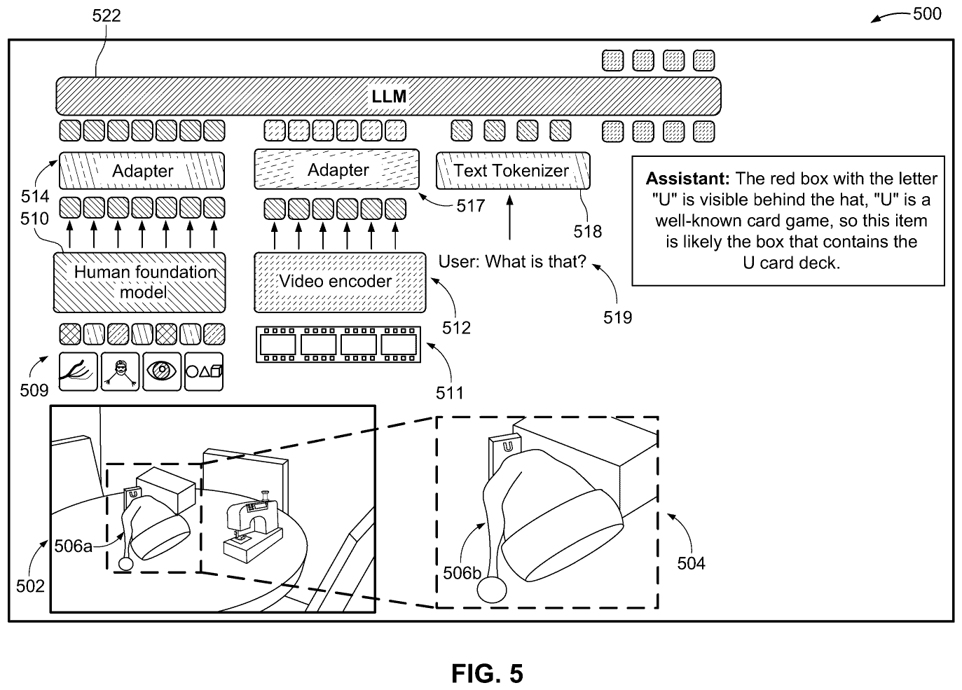

FIG. 5 illustrates a view of a system 500 that enables system activation using low-level signals as triggers, in accordance with some implementations. In some implementations, low-level signals obtained from sensors 509 (e.g., gaze detection sensors, motion detection sensors, wireless signal (long range and short range) disconnection sensors, etc.) may be used to trigger (via a human foundation model 510 and an adapter 514) the activation of higher-power components, such as cameras or language models such as LLM 522.

In some implementations when a trigger event is detected, system 500 may activate LLM 522 to further analyze the event via high-power, multimodal processing that obtains inputs such as images 511 (e.g., video frames) for processing via a video encoder 512 and an adapter 517 and text 519 for processing via a text tokenizer 518.

In some implementations, system 500 only activates high-power components (e.g., LLM 522 or a camera) when it detects that a relevant, human-centered event is happening (e.g., a user asking: “what is that” while pointing at an object such as, for example, a hat 506a). For example, when high level components such as a camera or LLM 522 are triggered, low-level signals obtained from sensors 509 (e.g., gaze focus, gestures, object interaction, etc.) are configured to provide additional context to guide the high-level system (system 500) to ensure that it does not process unnecessary data. For example, instead of analyzing an entire scene of an image 502, system 500 is configured to only process a relevant portion 504 of image 502 associated with an interaction such as gaze, hand gesture, and/or an audible request such as “what is that”? Accordingly, selectively capturing of information (e.g., portion 504 of image 502) may reduce the amount of data requiring processing thereby assisting an efficiency and latency of system 500.

In some implementations, system 500 enables cascading sensor and processing operations such that a low-power sensor (e.g., an audio sensor of sensors 509) is initialized to capture data, such as audio data, for input into LLM 522 (operating in a limited, single-modal capacity) configured to evaluate the audio data. Subsequently, a higher power sensor (e.g., a camera of sensors 509) may be enabled for providing input into the LLM 522 (now operating in a multi-modal capacity) to interpret environmental context and hand and gaze gestures. For example, operation of first low power/low compute sensor may be triggered upon detection of, for example, audio data such as speech. This operation may be configured to trigger a limited capacity of LLM 522 to interpret the speech and based on the interpreted speech, the second differing (and higher power) sensor (e.g., a cameras) may be triggered to capture images for evaluation of hand and gaze gestures to refine a result indicating a user request or command such as answering the question such as “what is that?”.

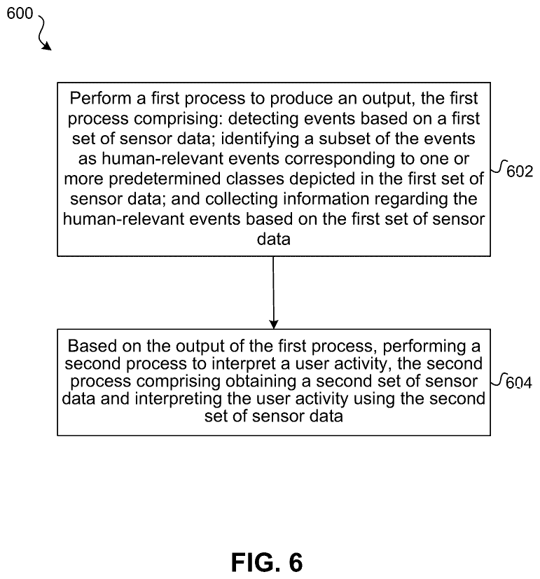

FIG. 6 is a flowchart representation of an exemplary method 600 that detects and interprets user activity via a resource-heavy process triggered and/or guided by determinations and decisions enabled by a resource-light process, in accordance with some implementations. In some implementations, the method 600 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 performs a first process (e.g., a resource-light process implemented via, for example, low-power system 210 of FIG. 2) to produce an output for triggering a second process such as a resource-heavy process implemented via, for example, high-power system 225 of FIG. 2. In some implementations, the first process includes:
1. Detecting events based on a first set of sensor data such as hand positions, gaze data, audio data, IMU data, etc. obtained via sensors such as OFC 217, IFC 218, sensor(s) 221, and IMU sensors 220, etc. as described with respect to FIG. 2.
2. Identifying a subset of the events as human-relevant events corresponding to one or more predetermined classes depicted in the first set of sensor data. For example, this may involve using an HFM 206 and relevance decoder 204 to identify events involving: hands and gaze, hand-object interaction, visual attention to objects, reading text, user-initiated speech or sound, human body movement, etc. as described with respect to FIG. 2.
3. Collecting information regarding the human-relevant events based on the first set of sensor data.

In some implementations, the first set of sensor data includes data selected from the group consisting of hand position data, gaze data, audio data, and IMU data.

At block 604, based on the output of the first process (e.g., triggered by or using information from), the method 600 performs a second process to interpret a user activity. The second process may include obtaining a second set of sensor data (e.g., vision sensors, increase frame rate, increase resolution, etc. as described with respect to FIG. 1) and interpreting the user activity using the second set of sensor data. For example, interpreting the user activity may include computationally intensive processes such as LLM 228 processing as described with respect to FIG. 2.

In some implementations, the second process may be triggered based on detection of a human-relevant event by the first process. In some implementations, the human-relevant event include may include an event such as, inter alia, an audible sound, an interaction with an object, user movement, etc.

In some implementations, the second process may use an output of the first process (e.g., information regarding the human relevant events) to interpret the user activity.

In some implementations, interpreting the user activity may include classifying current events of the subset of the events.

In some implementations, interpreting the user activity comprises interpreting a verbal utterance in combination with a user gaze, gesture, body movement, body language, or facial expression.

In some implementations, the second set of sensor data may include data such as, for example, vision sensor data, frame rate data, video resolution data, etc.

In some implementations, interpreting the user activity using the second set of sensor data may include using LLM processing.

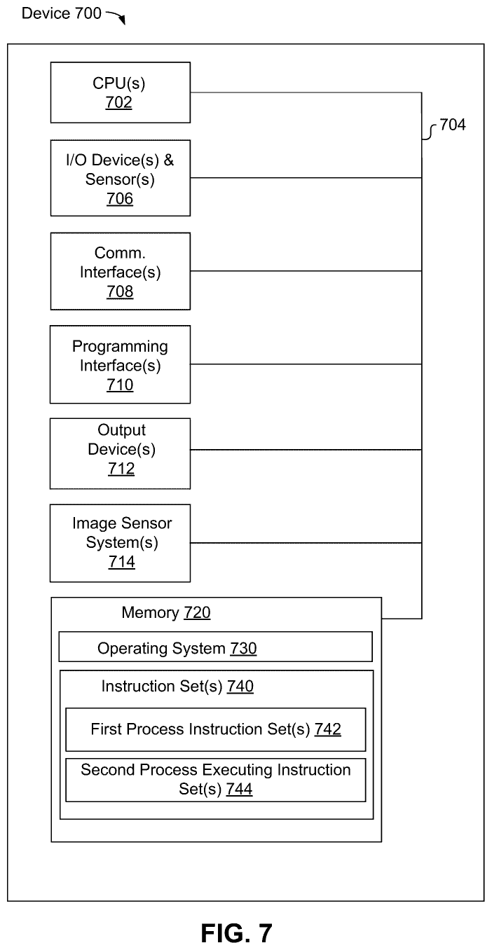

FIG. 7 is a block diagram of an example device 700. Device 700 illustrates an exemplary device configuration for electronic device 105 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 710, output devices (e.g., one or more displays) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 712 are configured to present a view of a physical environment, a graphical environment, an extended reality environment, etc. to the user. In some implementations, the one or more displays 712 are configured to present content (determined based on a determined user/object location of the user within the physical environment) to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 712 correspond to diffractive, reflective, polarized, holographic, etc. waveguide displays. In one example, the device 700 includes a single display. In another example, the device 700 includes a display for each eye of the user.

In some implementations, the one or more image sensor systems 714 are configured to obtain image data that corresponds to at least a portion of the physical environment 100. For example, the one or more image sensor systems 714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

In some implementations, the device 700 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 700 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 700.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes a data element generation instruction set 742, a first process executing instruction set 744, and a second process executing instruction set 746. The instruction set(s) 740 may be embodied as a single software executable or multiple software executables.

The first process executing instruction set 742 is configured with instructions executable by a processor to execute (e.g., continuously) a resource-light process with respect to initial sensor data to trigger a second process for a more detailed interpretation of user activity.

The second process executing [should “executing” be here? Should it be in the figure?—note difference between 742 and 744 in FIG. 7] instruction set 744 is configured with instructions executable by a processor to execute resource-heavy process (triggered by the resource-light process) to interpret a user activity based on additional sensor data differing from the initial sensor data.

The utterance interpretation instruction set 746 [I don't see this in the figure] is configured with instructions executable by a processor to interpret the utterance using a subset of the data elements based on the timing attributes.

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Returning to FIG. 1, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having a processor and one or more sensors:
performing a first process to produce an output, the first process comprising:
detecting events based on a first set of sensor data;
identifying a subset of the events as human-relevant events corresponding to one or more predetermined classes depicted in the first set of sensor data; and
collecting information regarding the human-relevant events based on the first set of sensor data; and
based on the output of the first process, performing a second process to interpret a user activity, the second process comprising obtaining a second set of sensor data and interpreting the user activity using the second set of sensor data.

2. The method of claim 1, wherein the second process is triggered based on detection of a human-relevant event by the first process.

3. The method of claim 2, wherein the human-relevant event comprises an event selected from the group consisting of an audible sound, an interaction with an object, and user movement.

4. The method of claim 1, wherein the second process uses the output of the first process to interpret the user activity, the output comprises the information regarding the human relevant events.

5. The method of claim 1, wherein said interpreting the user activity comprises classifying current events of the subset of the events.

6. The method of claim 1, wherein said interpreting the user activity comprises interpreting a verbal utterance in combination with a user gaze, gesture, body movement, body language, or facial expression.

7. The method of claim 1, wherein the first set of sensor data comprises data selected from the group consisting of hand position data, gaze data, audio data, and IMU data.

8. The method of claim 1, wherein the second set of sensor data comprises data selected from the group consisting of vision sensor data, frame rate data, and video resolution data.

9. The method of claim 1, wherein said interpreting the user activity using the second set of sensor data comprises using large language model (LLM) processing.

10. An electronic device comprising:
one or more sensors;
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
performing a first process to produce an output, the first process comprising:
detecting events based on a first set of sensor data;
identifying a subset of the events as human-relevant events corresponding to one or more predetermined classes depicted in the first set of sensor data; and
collecting information regarding the human-relevant events based on the first set of sensor data; and
based on the output of the first process, performing a second process to interpret a user activity, the second process comprising obtaining a second set of sensor data and interpreting the user activity using the second set of sensor data.

11. The electronic device of claim 10, wherein the second process is triggered based on detection of a human-relevant event by the first process.

12. The electronic device of claim 11, wherein the human-relevant event comprises an event selected from the group consisting of an audible sound, an interaction with an object, and user movement.

13. The electronic device of claim 10, wherein the second process uses the output of the first process to interpret the user activity, the output comprises the information regarding the human relevant events.

14. The electronic device of claim 10, wherein said interpreting the user activity comprises classifying current events of the subset of the events.

15. The electronic device of claim 10, wherein said interpreting the user activity comprises interpreting a verbal utterance in combination with a user gaze, gesture, body movement, body language, or facial expression.

16. The electronic device of claim 10, wherein the first set of sensor data comprises data selected from the group consisting of hand position data, gaze data, audio data, and IMU data.

17. The electronic device of claim 10, wherein the second set of sensor data comprises data selected from the group consisting of vision sensor data, frame rate data, and video resolution data.

18. The electronic device of claim 10, wherein said interpreting the user activity using the second set of sensor data comprises using large language model (LLM) processing.

19. A non-transitory computer-readable storage medium storing program instructions executable via one or more processors to perform operations comprising:
performing a first process to produce an output, the first process comprising:
detecting events based on a first set of sensor data;
identifying a subset of the events as human-relevant events corresponding to one or more predetermined classes depicted in the first set of sensor data; and
collecting information regarding the human-relevant events based on the first set of sensor data; and
based on the output of the first process, performing a second process to interpret a user activity, the second process comprising obtaining a second set of sensor data and interpreting the user activity using the second set of sensor data.

20. The non-transitory computer-readable storage medium of claim 19, wherein the second process is triggered based on detection of a human-relevant event by the first process.
